(19) United States
(12) Patent Application Publication
(10) Pub. No.: US 2011/0023491 A1
(43) Pub. Date: Feb. 3, 2011

(54) SYSTEM AND METHOD FOR SUPPLYING FUEL TO A GAS TURBINE

(75) Inventors: KOREY FREDERIC RENDO, GREER, SC (US); COLIN WILKES, ANDERSON, SC (US); DANIEL MARTIN MOSS, SIMPSONVILLE, SC (US); TIMOTHY RUSSELL BILTON, SIMPSONVILLE, SC (US)

Correspondence Address: Dority & Manning, PA and General Electric Company, Post Office Box 1449, Greenville, SC, 29602, US

(73) Assignee: GENERAL ELECTRIC COMPANY, SCHENECTADY, NY (US)

(21) Appl. No.: 12/512,527

(22) Filed: Jul. 30, 2009

(51) Int. Cl. F02C 7/22; G05D 11/00

(52) U.S. Cl. 60/734; 137/115.13

(57) ABSTRACT

A system for supplying fuel to a gas turbine includes piping containing fuel at a pressure greater than approximately 500 psi. A pressure reducing valve connected downstream of the piping reduces the pressure of the fuel to less than approximately 200 psi. A heat exchanger connected downstream of the pressure reducing valve heats the wet saturated fuel or dry saturated fuel to produce a superheated fuel. A control valve connected downstream of the heat exchanger reduces the pressure of the superheated fuel to less than approximately 50 psi. A method for supplying superheated fuel to a gas turbine includes receiving fuel having a pressure greater than approximately 500 psi and reducing the pressure to less than approximately 200 psi. The method further includes separating gaseous fuel from liquid fuel, reducing the pressure of the gaseous fuel to less than approximately 50 psi, and flowing the superheated fuel to the gas turbine.

### FIELD OF THE INVENTION

The present invention generally involves a gas turbine fuel system. More particularly, the present invention describes a fuel system that can supply superheated gas fuel to a gas turbine.

### BACKGROUND

Gas turbines are widely used in commercial operations for power generation. Gas turbines generally include a compressor at the front, one or more combustors around the middle, and a turbine at the rear. The compressor progressively compresses a working fluid and discharges the compressed working fluid to the combustors. The combustors inject fuel into the flow of compressed working fluid and ignite the mixture to produce combustion gases having a high temperature, pressure, and velocity. The combustion gases exit the combustors and flow to the turbine where they expand to produce work.

Liquids from condensed gases in the fuel produce serious detrimental effects in the combustors that may result in hardware damage. The fuel supplier typically provides strict controls to reduce the moisture content of the fuel. However, additional fuel processing is required to ensure that the fuel provided to the combustors is essentially free of liquids.

FIG. 1 shows a simplified diagram of a typical fuel system 10 for supplying fuel to a gas turbine 12. The fuel system 10 generally includes a supply of fuel 14 having a pressure of approximately 500-700 pounds per square inch. The fuel may be wet saturated (defined as having a temperature and pressure below the hydrocarbon dew point), dry saturated (defined as having a temperature and pressure equal to the hydrocarbon dew point), or superheated (defined as having a temperature and pressure above the hydrocarbon dew point). The fuel flows through a separator 16, and the separator 16 removes any condensed fluids (e.g., water, condensed hydrocarbons, etc.) from the fuel. A flow control valve 18 throttles the flow of fuel to the combustors of the gas turbine 12. As the fuel expands through the flow control valve 18, the Joule-Thomson effect causes a decrease in the temperature of the fuel. The expansion of the fuel may cause the fuel temperature to fall below the hydrocarbon dew point, allowing condensate to form. To prevent the fuel temperature from falling below the hydrocarbon dew point, the fuel system typically includes one or more heat exchangers 20, 22 upstream of the flow control valve 18. The heat exchangers 20, 22 add heat to the fuel to superheat the fuel and ensure that the fuel temperature remains above the hydrocarbon dew point at all times.

FIG. 2 provides a graphical representation of the temperature and pressure changes in the fuel as it moves through the fuel system. For purposes of illustration, FIG. 2 illustrates the fuel entering the fuel system as superheated fuel, indicated by point A. The heat exchangers 20, 22 heat the fuel to increase the fuel temperature to point B. As the fuel expands through the flow control valve 18, the Joule-Thomson effect reduces the temperature of the fuel from point B to point C. Notably, the gas expansion path from point B to point C remains above the hydrocarbon dew point at all times, preventing condensation in the fuel. The distance between points A and B represents the amount of superheat provided by the heat exchangers 20, 22 to ensure the fuel temperature remains above the hydrocarbon dew point at all times to prevent condensation.

Multiple heat exchangers are typically necessary to ensure that an adequate heat source is available during all levels of operation. For example, during normal operations, the gas turbine 12 may supply the necessary heat. Hot compressed working fluid from the compressor or high temperature exhaust gases from the turbine may be extracted and supplied to one heat exchanger 22 to adequately superheat the fuel. However, during startup operations, heat is not readily available from the gas turbine 12, thus requiring a second heat exchanger 20 with an independent heat source 24.

The need for a second heat exchanger with an independent heat source to supply heat during start up operations requires additional capital costs in the construction of the gas turbine system. In addition, the second heat exchanger typically uses heating coils, an indirect fired heater, a heat pump, or similar devices for providing heat that consumes additional power or fuel during the start up that is typically in scarce supply. Moreover, the power consumed by the second heat exchanger to superheat the fuel decreases the overall efficiency of the gas turbine plant.

Therefore, the need exists for an improved fuel supply system that can provide superheated fuel to the gas turbine during startup. Ideally, the fuel supply system will not require additional capital costs for an independent heat source and will not require a substantial amount of additional power that is in short supply while starting up the gas turbine.

### BRIEF DESCRIPTION OF THE INVENTION

Aspects and advantages of the invention are set forth below in the following description, or may be obvious from the description, or may be learned through practice of the invention.

One embodiment of the present invention is a system for supplying fuel to a gas turbine. The system includes piping that contains a supply of fuel at a pressure greater than approximately 500 pounds per square inch. Means for reducing the pressure of the supply of fuel is connected downstream of the piping to reduce the pressure of the supply of fuel to less than approximately 200 pounds per square inch. A separator is connected downstream of the means for reducing the pressure of the supply of fuel, and the separator includes a gaseous port and a liquid port. A control valve is connected to the gaseous port, and the control valve reduces the pressure of the supply of fuel to produce a superheated fuel having a pressure of less than approximately 50 pounds per square inch.

In another embodiment of the present invention, a system for supplying fuel to a gas turbine includes piping that contains a supply of fuel at a pressure greater than approximately 500 pounds per square inch. A pressure reducing valve is connected downstream of the piping, and the pressure reducing valve is configured to reduce the pressure of the supply of fuel to less than approximately 200 pounds per square inch. A heat exchanger is connected downstream of the pressure reducing valve to heat the supply of fuel. A control valve is connected downstream of the heat exchanger, and the control valve reduces the pressure of the supply of fuel to less than approximately 50 pounds per square inch.

The present invention further includes a method for supplying superheated fuel to a gas turbine. The method includes receiving a supply of fuel having a pressure greater than approximately 500 pounds per square inch and reducing the pressure of the supply of fuel to less than approximately 200 pounds per square inch to produce a wet saturated fuel having a mixture of gaseous fuel and liquid fuel. The method further includes separating the gaseous fuel from the liquid fuel, reducing the pressure of the gaseous fuel to less than approximately 50 pounds per square inch to produce a superheated fuel, and flowing the superheated fuel to the gas turbine.

Those of ordinary skill in the art will better appreciate the features and aspects of such embodiments, and others, upon review of the specification.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a simplified diagram of a typical system for supplying fuel to a gas turbine;

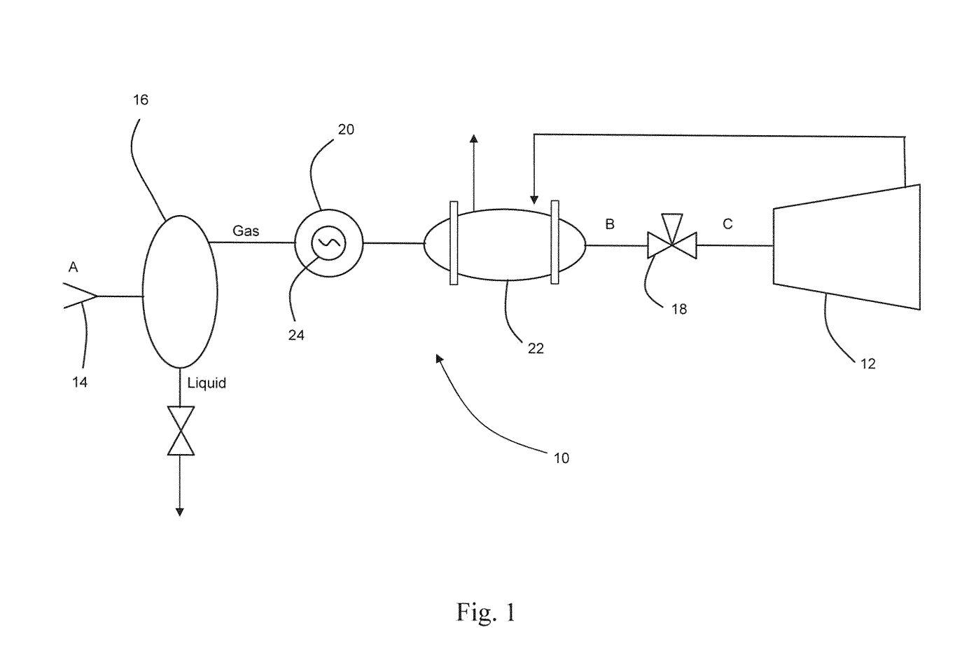

FIG. 2 is a graphical representation of the pressure and temperature of the fuel supplied in FIG. 1;

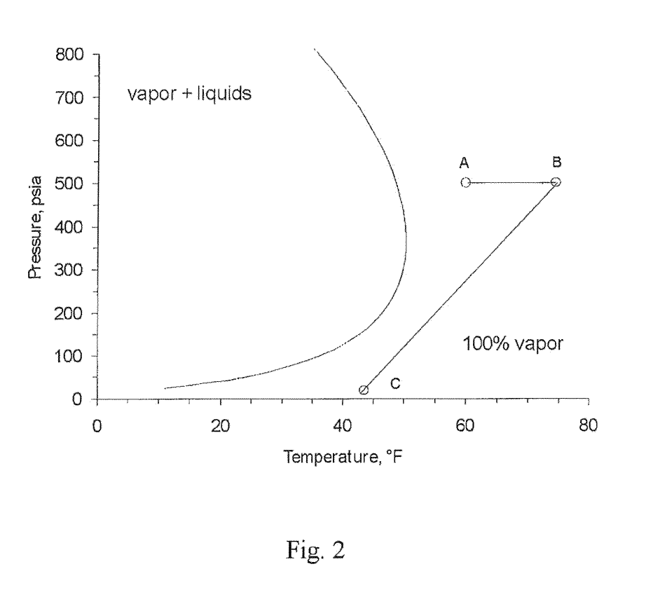

FIG. 3 is a simplified diagram of a system for supplying fuel to a gas turbine according to one embodiment of the present invention; and

FIG. 4 is a graphical representation of the pressure and temperature of the fuel supplied in FIG. 3.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

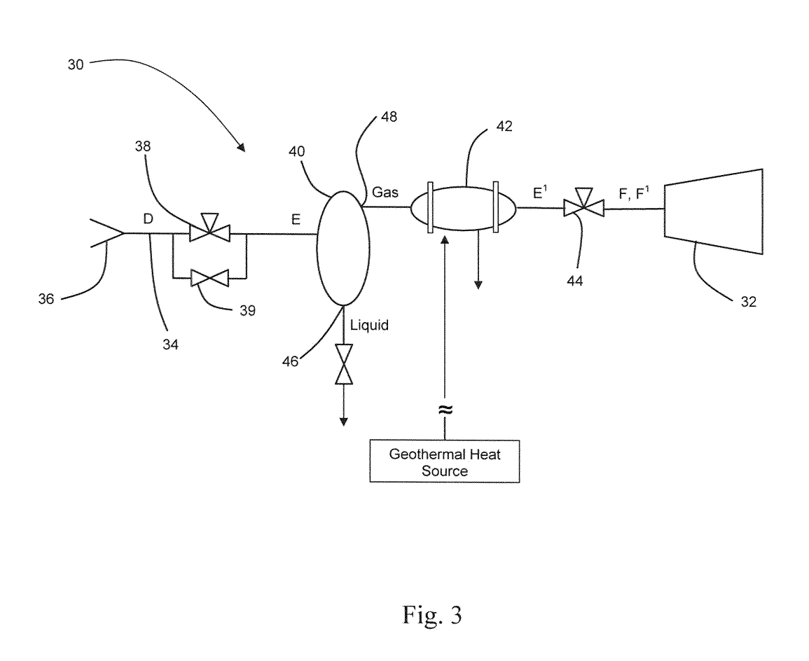

FIG. 3 provides a simplified diagram of a fuel system 30 for a gas turbine 32 according to one embodiment of the present invention. The fuel system 30 generally includes piping 34 containing a supply of fuel 36, means for reducing the pressure of the supply of fuel 38, a separator 40, a heat exchanger 42, and a control valve 44.

The piping 34 contains the supply of fuel 36 and transfers the supply of fuel 36 from its source to the fuel system 30. The supply of fuel 36 may be any fuel suitable for combustion in a gas turbine. Possible fuels used by commercial combustion engines include blast furnace gas, coke oven gas, natural gas, vaporized liquefied natural gas (LNG) and propane. The fuel typically has a pressure of approximately 500-700 pounds per square inch and a temperature of approximately 50-70 degrees Fahrenheit, depending on the geographic region, pipe insulation, and heat tracing. As natural gas and vaporized LNG fuel is typically transported to the fuel system 30 through underground piping, the actual temperature and pressure of the fuel may vary according to the time of year, fuel supplier, location, and other environmental conditions. The supplier may deliver the fuel as wet saturated fuel (i.e., having a temperature and pressure below the hydrocarbon dew point), dry saturated fuel (i.e., having a temperature and pressure equal to the hydrocarbon dew point), or superheated fuel (i.e., having a temperature and pressure above the hydrocarbon dew point).

The means for reducing the pressure of the supply of fuel 38 is connected downstream of the piping 34 containing the supply of fuel 36. The means for reducing the pressure of the supply of fuel 38 may include one or more Joule-Thomson valves, pressure reducing valves, throttle valves, variable orifices, or any valve through which a gas is allowed to expand adiabatically, resulting in lowering of its temperature due to the Joule-Thomson effect. A bypass valve 39 may be used in conjunction with the means for reducing the pressure of the supply of fuel 38 to extend the maximum operational flow range as needed. The fuel flows through the piping 34 to the means for reducing the pressure of the supply fuel 38, and the means for reducing the pressure of the supply of fuel 38 reduces the pressure of the fuel to less than approximately 200 pounds per square inch. As the pressure of the fuel decreases, the Joule-Thomson effect causes the temperature of the fuel to decrease approximately 0.06-0.07 degrees Fahrenheit per pound per square inch of pressure drop, with the actual temperature drop dependent on the composition and temperature of the incoming fuel. The fuel exiting the means for reducing the pressure of the supply of fuel 38 may therefore be dry saturated (i.e., at the hydrocarbon dew point) or wet saturated (i.e., below the hydrocarbon dew point) fuel. The actual state of the fuel depends on various factors, such as the specific fuel being used and the temperature and pressure of the fuel exiting the means for reducing the pressure of the supply of fuel 38.

The separator 40 and heat exchanger 42 are connected downstream of the means for reducing the pressure of the supply of fuel 38 to condition the fuel prior to reaching the control valve 44. Although both the separator 40 and the heat exchanger 42 are illustrated in FIG. 3, additional embodiments within the scope of the present invention may include only the separator 40, while other embodiments may include only the heat exchanger 42.

The separator 40, if present, removes any liquids present in the wet saturated or dry saturated fuel exiting the means for reducing the supply of fuel 38. The separator 40 may include a coalescing filter, an inertial separator and mist eliminator, or other structure known in the art for physically separating gases and liquids with high efficiency. In other embodiments, the separator 40 may include an absorption tower having an absorbent oil that removes the liquid fuel from the fuel stream. The separator 40 discharges the liquids through a liquid port 46 for recycling or further use in the fuel system. Gaseous fuel flows out of the separator 40 through a gaseous port 48 as dry saturated fuel (i.e., at the hydrocarbon dew point) or superheated fuel (i.e., above the hydrocarbon dew point). Again, the actual state of the gaseous fuel depends on various factors, such as the specific fuel being used and the temperature and pressure of the gaseous fuel exiting the separator 40.

The heat exchanger 42, if present, provides heat to the fuel after it has passed through the means for reducing the pressure of the supply of fuel 38 and the separator 40 (if present). Due to the relatively low temperature of the fuel after expansion, the heat exchanger 42 does not require a high temperature heat source to increase the temperature of the fuel to above the hydrocarbon dew point. As a result, the heat exchanger 42 may use, for example, a geothermal heat source 50. A geothermal heat source 50 includes any heat source that uses the earth's relatively constant temperature as a source of heat. Examples include, but are not limited to, subterranean water, ambient air, and potentially even the supply of fuel 36, which is typically transported through underground piping, as described in “Concept for passive heating at meter/gate stations” authored by Dr. Wayne S. Hill and Elizabeth C. Poulin and published Feb. 1, 1992. Alternate, more conventional energy sources, such as steam from an auxiliary boiler, may also be used, but a high temperature energy source is not a requirement for this application.

The heat exchanger 42 increases the temperature of the fuel to above the hydrocarbon dew point. If the separator 40 is present, the gaseous fuel exiting the heat exchanger 42 will likely be superheated fuel (i.e., above the hydrocarbon dew point). If the separator 40 is not used, the fuel exiting the heat exchanger 42 may be dry saturated (i.e., at the hydrocarbon dew point) or superheated (i.e., above the hydrocarbon dew point) fuel. As previously discussed, the actual state of the fuel depends on various factors, such as the specific fuel being used and the temperature and pressure of the fuel exiting the means for reducing the pressure of the supply of fuel 38 or separator 40.

The control valve 44 is connected downstream of the separator 40 and/or heat exchanger 42 and controls the flow of fuel to the gas turbine 32. The control valve 44 may be a Joule-Thomson valve, a throttle valve, a variable orifice, or similar device known to one of ordinary skill in the art for regulating fluid flow. During the start up of the gas turbine 32, the control valve 44 further reduces the pressure of the dry saturated or superheated fuel to produce a superheated fuel having a pressure of between approximately 25 and 50 pounds per square inch, depending on the start up needs of the gas turbine 32. The desired fuel pressure gradually increases as load is applied to the gas turbine 32, and the control valve 44 adjusts accordingly to provide superheated fuel at the desired pressure. At some point, the gas turbine 32 is operating at a sufficient level to allow the extraction of hot compressed working fluid from the compressor or high temperature exhaust gases from the turbine to provide additional superheat to the fuel.

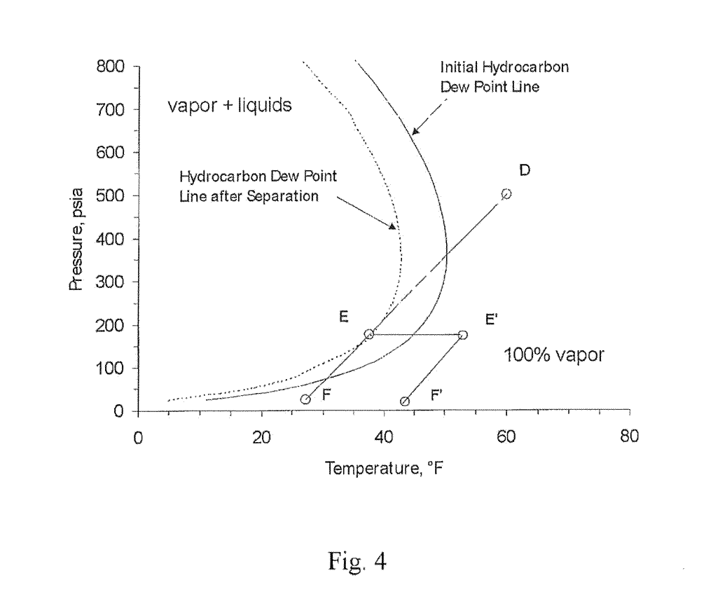

FIG. 4 is a graphical representation of the pressure and temperature of the fuel supplied in FIG. 3. The fuel entering the fuel system 30 may be wet saturated fuel (i.e., below the hydrocarbon dew point), dry saturated fuel (i.e., at the hydrocarbon dew point), or superheated fuel (i.e., above the hydrocarbon dew point). For purposes of illustration, FIG. 4 illustrates the fuel entering the fuel system 30 as superheated fuel, as indicated by point D.

The means for reducing the pressure of the supply of fuel 38 reduces the pressure and temperature of the fuel, as indicated by the line D-E. As previously discussed, the fuel exiting the means for reducing the pressure of the supply of fuel 38 may be dry saturated fuel (i.e., at the hydrocarbon dew point) or wet saturated fuel (i.e., below the hydrocarbon dew point). For purposes of illustration, FIG. 4 illustrates the fuel exiting the means for reducing the pressure of the supply of fuel 38 as being wet saturated fuel, as indicated by point E.

The fuel then passes through the separator 40 and/or heat exchanger 42. If a separator 40 is present, the separator 40 removes the condensed liquid from the fuel, resulting in a new hydrocarbon dew point for the gaseous fuel, as indicated by the dashed curve in FIG. 4. As previously discussed, the gaseous fuel flowing out of the separator 40 may be dry saturated (i.e., at the hydrocarbon dew point) or superheated (i.e., above the hydrocarbon dew point) fuel. For purposes of illustration, FIG. 4 illustrates the fuel exiting the separator 40 as dry saturated fuel, as indicated by point E being on the dashed curve for the new hydrocarbon dew point.

If the heat exchanger 42 is not present, the dry saturated fuel then flows through the control valve 44 which further reduces the temperature and pressure of the gaseous fuel, as indicated by the line E-F, creating superheat as the gas expansion path deviates from the new hydrocarbon dew point curve. This occurs because the change in temperature with respect to the change in pressure (ΔT/ΔP) created by the control valve 44 has a greater slope than the new hydrocarbon dew point curve. Therefore, the novel combination of the means for reducing the pressure of the supply of fuel 38, separator 40, and control valve 44 produces superheated fuel to the gas turbine 32 during start up without the need for a start up heat exchanger, as indicated by the line segments D-E-F in FIG. 4 (with a new hydrocarbon dew point indicated by the dashed curve).

If a heat exchanger is present with the separator 40, the heat exchanger 42 increases the temperature of the dry saturated fuel exiting the separator 40, as indicated by the line E-E′. This additional superheating of the gaseous fuel provides an additional margin to further ensure that the fuel supplied to the gas turbine 32 remains free of any liquids or condensate. The superheated gaseous fuel then flows through the control valve 44 which further reduces the temperature and pressure of the fuel, as indicated by the line E′-F′. Therefore, the novel combination of the means for reducing the pressure of the supply of fuel 38, separator 40, heat exchanger 42, and control valve 44 produces superheated fuel to the gas turbine 32 during start up, as indicated by the line segments D-E-E′-F′ in FIG. 4 (with a new hydrocarbon dew point indicated by the dashed curve).

If the separator 40 is not present, the heat exchanger 42 increases the temperature of the wet saturated fuel exiting the means for reducing the pressure of the supply of fuel 38, as indicated by the line E-E′. For this embodiment without a separator, the hydrocarbon dew point remains unchanged, and the heat exchanger 42 superheats the wet saturated fuel to produce superheated fuel free of any liquids or condensate. The superheated fuel then flows through the control valve 44 which further reduces the temperature and pressure of the fuel, as indicated by the line E′-F′. Therefore, the novel combination of the means for reducing the pressure of the supply of fuel 38, heat exchanger 42, and control valve 44 produces superheated fuel to the gas turbine 32 during start up, as indicated by the line segments D-E-E′-F′ in FIG. 4 (with no change in the hydrocarbon dew point).

It should be appreciated by those skilled in the art that modifications and variations can be made to the embodiments of the invention set forth herein without departing from the scope and spirit of the invention as set forth in the appended claims and their equivalents.

What is claimed is:

1. A system for supplying fuel to a gas turbine, comprising:
a. piping, wherein the piping contains a supply of fuel at a pressure greater than approximately 500 pounds per square inch;
b. means for reducing the pressure of the supply of fuel connected downstream of the piping to reduce the pressure of the supply of fuel to less than approximately 200 pounds per square inch;
c. a separator connected downstream of the means for reducing the pressure of the supply of fuel, wherein the separator includes a gaseous port and a liquid port; and
d. a control valve connected to the gaseous port, wherein the control valve reduces the pressure of the supply of fuel to produce a superheated fuel having a pressure of less than approximately 50 pounds per square inch.

2. The system of claim 1, further including a heat exchanger connected downstream of the means for reducing the pressure of the supply of fuel.

3. The system of claim 2, wherein the heat exchanger includes a geothermal heat source.

4. The system of claim 1, wherein the means for reducing the pressure of the supply of fuel includes a Joule-Thomson valve.

5. The system of claim 1, wherein the means for reducing the pressure of the supply of fuel includes a variable orifice.

6. The system of claim 1, wherein the separator includes a coalescing filter.

7. The system of claim 1, wherein the separator includes an absorption tower having an absorbent oil.

8. A system for supplying fuel to a gas turbine, comprising:
a. piping, wherein the piping contains a supply of fuel at a pressure greater than approximately 500 pounds per square inch;
b. a pressure reducing valve connected downstream of the piping, the pressure reducing valve configured to reduce the pressure of the supply of fuel to less than approximately 200 pounds per square inch;
c. a heat exchanger connected downstream of the pressure reducing valve to heat the supply of fuel; and
d. a control valve connected downstream of the heat exchanger, wherein the control valve reduces the pressure of the supply of fuel to less than approximately 50 pounds per square inch.

9. The system of claim 8, further including a separator connected downstream of the pressure reducing valve, wherein the separator includes a gaseous port and a liquid port.

10. The system of claim 9, wherein the separator includes a coalescing filter.

11. The system of claim 9, wherein the separator includes an absorption tower having an absorbent oil.

12. The system of claim 8, wherein the heat exchanger includes a geothermal heat source.

13. A method for supplying superheated fuel to a gas turbine, comprising:
a, receiving a supply of fuel having a pressure greater than approximately 500 pounds per square inch;
b. reducing the pressure of the supply of fuel to less than approximately 200 pounds per square inch to produce a wet saturated fuel having a mixture of gaseous fuel and liquid fuel;
c. separating the gaseous fuel from the liquid fuel;
d. reducing the pressure of the gaseous fuel to less than approximately 50 pounds per square inch to produce a superheated fuel; and
e. flowing the superheated fuel to the gas turbine.

14. The method of claim 13, further including heating the gaseous fuel.

15. The method of claim 13, further including heating the gaseous fuel with a geothermal heat source.

16. The method of claim 13, further including reducing the pressure of the gaseous fuel to less than approximately 30 pounds per square inch.
